(19) United States
(12) Patent Application Publication
(10) Pub. No.: US 2005/0028005 A1
(43) Pub. Date: Feb. 3, 2005

(54) Automated accreditation system

(75) Inventors: Ann F. Carson, Rockville, MD (US); James Ross McGurrin, Falls Church, VA (US); Ivanhoe L. Lindo, Washington, DC (US); Phyllis Torda, Washington, DC (US); Marsha Kaufman, Washington, DC (US); Patrick Dahill, Arlington, VA (US); Carolyn Jane Moeller, Gaithersburg, MD (US); William Fenton Tulloch, Washington, DC (US); Gerald Stewart, Washington, DC (US); Helena Joy Hamilton, Washington, DC (US); Jonathan F. Cook, Pittsburgh, PA (US); Xiaoli Jiao, Washington, DC (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: NCQA

(21) Appl. No.: 10/840,420

(22) Filed: May 7, 2004

Related U.S. Application Data
(60) Provisional application No. 60/468,296, filed on May 7, 2003.

(51) Int. Cl. H04L 9/00

(52) U.S. Cl. 713/200

(57) ABSTRACT

The present invention provides a sophisticated automated accreditation and certification platform that substantially streamlines the oversight process, reducing the duration of the on-site survey, eliminating paper and allowing for the efficient, electronic transfer of documents. In addition, the online process is interactive, allowing users to get up-front feedback on standards compliance and perform a self-assessment prior to their actual survey. The invention allows the creation of an automated survey and the association of accreditation criteria with the questions in the automated survey.

### CROSS REFERENCE TO RELATED APPLICATIONS

The present invention claims priority from United States Provisional Application No. 60/468,296 filed on May 7, 2003,the subject matter of which is hereby incorporated by reference in full.

### STATEMENT REGARDING SPONSORED RESEARCH OR DEVELOPMENT

Not Applicable.

### REFERENCE TO SEQUENCE LISTING

Not Applicable.

### BACKGROUND OF THE INVENTION

1. Field of the Invention

The present invention relates to a system and method for generating standards and scoring to assess organizations undergoing accreditation or certification and includes a system for permitting organizations to electronically self-assess against such standards and then undergo an accreditation or certification survey that results in an electronic assessment report.

2. Discussion of the Related Prior Art

The process of accrediting or certifying various organizations, such as health plans, may be quite complicated and labor intensive. Assessment of organizations against standards and guidelines for accreditation or certification purposes is often a document-intensive and labor-intensive process. In particular, the creation of electronically administered accreditation standards and guidelines is costly process, generally requiring the creation of custom applications. Several software tools exist for assisting in the creation of a survey, but these applications are not much more than word processing-type applications that accept input data and assist the user in specifying the presentation of this data. These automated may also assist in the disbursement of the survey questions (e.g., transmitting the survey over a network) and receiving and storing survey replies.

The known survey applications have little value as automated accreditation tools. Specifically, the know software tools do not allow a user to define the conditions or criteria for passing/failing accreditation. Thus, survey answers would still need to be manually evaluated by a skilled staffed trained in interpreting the survey answers, and self-assessment by survey-takers would not be possible. Moreover, the know tools give no guidance to users as to the actions needed to meet accreditation criteria. Information from the accreditation or certification results needs to be made available to users of the information in a meaningful comparative ways.

Furthermore, Accreditations typically entails the collection of data and paperwork needed to support the submitted answers to a survey, and the known tools do not assist in or automate in the collection of this data and paperwork.

Thus, there is a need for an electronic platform that enables accrediting and certifying bodies and other organizations that assess performance against standards to generate interactive electronic standards, guidelines and scoring methods. Thus there is current need for an automated system to assist in the collection and assessment of data related to accrediting or certifying various organizations.

### SUMMARY OF THE INVENTION

In response to these and other needs, the present invention provides a sophisticated online accreditation and certification platform that substantially streamlines the oversight process, reducing the duration of the on-site survey, eliminating paper and allowing for the efficient, electronic transfer of documents. In addition, the online process is interactive, allowing users to get up-front feedback on standards compliance and perform a self-assessment prior to their actual survey.

The present invention provides a Standards, Guidelines and Assessment Tool (SGAT) for accreditation and certification programs. The present invention represents a unique and novel online accreditation/certification platform, and also provides a significant step forward in online program documentation. Web-based assessment emphasizes the collection and exchange of information via the Internet, allowing for shorter, more efficient reviews. It also allows participating organizations to perform a complete self-assessment prior to their survey.

The present invention's provides an interactive, online Web-based tool that allows organizations to transfer supporting information and documentation, reducing the amount of time on site. The result is surveying lower costs and expedited turnaround time for results.

The present invention is structured so that organizations will be able to prepare themselves for a review more quickly and effectively-information is requested in a logical, layered manner, allowing for a quick, orderly transition of information from company databases to the accrediting/surveying authority. The present invention also provides tools organizations can use to assess their readiness. During the review, the accrediting/surveying authority and participating organizations exchange documents over the Web via secure, encrypted transfers.

In addition, the present invention allows each organization to receive a detailed performance report with accreditation or certification decisions. These reports may help organizations identify areas where improvement is needed, allowing them to develop enhanced, more effective quality improvement initiatives, and to prepare more effectively for subsequent reviews.

In one implementation, the current invention efficiently evaluates a variety of organizations and makes maximum use of electronic information. The system and method of the present invention improve the accreditation process by focusing on the policy (how to present the standards and the development process), process (how the surveys are conducted), and the systems to support both. This includes migrating the products to web-based tools to deliver the standards and collect data. Furthermore, the present invention improves an organization's experience with an accrediting/certifying organization, enhances product development, improves information architecture and increases operational efficiency.

The present invention includes an Interactive Survey System (ISS) that is an interactive, web-based platform that supports every aspect of Accreditation and certification. It contains a customized Survey Tool and the latest Standards and Guidelines. The Survey Tool reduces the paperwork and binder preparation previously associated with the survey process and allows users to prepare and submit accreditation materials electronically. Because much of the survey will be conducted off-site through use of the survey tool, any on-site portion of the survey process may be reduced in length and scope. The Survey Tool further permits an organization to conduct an evaluation to help determine readiness for a review and identify areas of special concern.

The ISS includes two components and an accrediting/certifying body may license these components to the organizations undergoing a survey, or to other interested parties such as consultants, regulators, etc. The first component is a web-based standards and guidelines (SG) that presents all of the information from the traditional hard-copy publications—the standards, elements, scoring, explanations, examples, supplemental worksheets, policies and procedures, and appendices in a searchable, layered format. The second component is the web-based survey tool (ST) the SG is imbedded in the ST, but the ST provides additional functionality that supports all aspects of the accreditation survey, including comments to support the assessment and send the data and documents via the web to an accrediting/certifying body as part of a survey. The survey process using the ST is described below.

To start the accreditation survey, the ST permits an organization to complete a pre-survey assessment by answering questions presented in the ST. The organization then uses the ST to submit the survey answers electronically to the accrediting/certifying authority. Based on this pre-survey assessment, the organization can see numerical score, which can help focus the survey preparation. Documents used to demonstrate compliance with the standards may be attached in electronic format to the ST and submitted with the data, using a document library that permits the documents to be referenced to the standards and elements.

Once submitted to accrediting/certifying authority, the accrediting/certifying authority may use the ST to conduct the accreditation survey. During the accreditation process, as the ST progresses through the stages of the survey, a phase of comments by the organization on preliminary results, and final decision-making, the organization may have access to specific data at stages specified in the operational processes. In general, these stages are the initial submission, the period where the organization reviews and provides comments on preliminary results and the final results. The organization will always have the ability to read any completed stages to which it had access rights.

At any point in the accreditation process, the organization may use the ST to print a copy of certain content present in the final stages to which it has access rights (i.e., initial submissions, preliminary results, final results).

The ST allows an organization to share information during the Accreditation process within the organization by giving designated staff access to the ST. The organization creates and manages its own user identifiers and passwords, giving it control of access.

Surveyors and staff of accrediting/certifying authority may be given access to designated areas of the ST and functions to review the organization's data and documents. At the appropriate point in the process, the decision-making committee reviews the data and documents by accessing the ST, and enters its decisions in a secure area specifically designed to support that function.

During the process, a user is given an opportunity to review preliminary results of the survey by access the web-based survey tool. The ST then provides organizations with a process to present their comments on the preliminary results to accrediting/certifying authority electronically.

The web-based ST has a document library that is used to track those documents identified by the organization as demonstrating compliance for standards. The document library categorizes documents alphabetically and by standard and references the particular element(s) that applies to each document. Organizations can use this library to keep all their documents updated and organized for future use.

The organization's final results are presented electronically via the ST. Instead of receiving a paper report, the organization may be notified that final results are available after the committee decision review and logs into the web-based ST to access their summary results, detailed results and score sheet. The organization may print a copy of the final results.

Thus, the present invention, not only shorten the duration of future on-site surveys, but also allow entities undergoing surveys to archive, modify and transfer documents and information electronically, eliminating paper and binders; provide multiple staff with access to survey-related documentation and allow updates to various sections of the survey materials at the same time; perform a self-assessment to gauge readiness for a survey; and view scores on individual elements or summary scores on various standards or sections of standards.

In a preferred embodiment, the present invention may further include an automated Completeness Check that automatically scans submission and flags any elements with no data.

The present invention preferably includes various levels of access so that different persons in an organization can view data from any PC with Internet access. An option feature may allow users to communicate with one another without concern that a surveyor will view these comments.

The self-assessment feature of the present invention allows an organization to answer the same questions for each element that surveyors complete while conducting a survey. Based on the data entered for the element, an organization can view its score on that element. In addition, once all the element data is complete, an organization may view aggregate scores at the standard, category and total Accreditation or Certification product level. In addition, if the score is below a specific threshold, the present invention may provide a recommendation on steps for improvement.

The present invention may also include a version control that allows an organization to have as many different. In order to ensure data integrity, the application generally may not allow two users on the same data entry page at a time.

The present invention may further include documentation regarding the Standards and Guidelines for Accreditation and Certification that detail the applicable standards for each Accreditation and Certification product.

In some implementations, the present invention conducts user surveys and electronic interviews through the dynamic creation of web pages to be transferred to and presented at a client display station. A hypertext document may include a plurality of survey questions having user selectable answers, and the selection of one of these answers triggers a hyperlink to a dynamically generated hypertext document with different questions, depending on the user's answer to the previous question. The survey and, consequently, the hypertext documents may be readily available from the World Wide Web or other network sources. The documents or pages used in the surveys are preferably dynamically generated HTML documents, such as DHTML that use scripting languages, such as Javasript in the generation of HTML pages.

### BRIEF DESCRIPTION OF THE DRAWINGS

A more complete understanding of the present invention and advantages thereof may be acquired by referring to the following description taken in conjunction with the accompanying drawings, in which like reference numbers indicate like features, and wherein:

FIG. 1 illustrates a block diagram of an automated accreditation system in accordance with embodiments of the present invention;

FIG. 2 represents the steps in a method for the automated creation of Accreditation Standards and Guidelines in accordance with embodiments of the present invention; and

FIG. 3 represents the steps in a method for the automated survey Tool that presents a survey as created according to the method of FIG. 2, the collection of survey data, and the presentation of accreditation results in accordance with embodiments of the present invention.

### DETAILED DESCRIPTION OF THE DRAWINGS

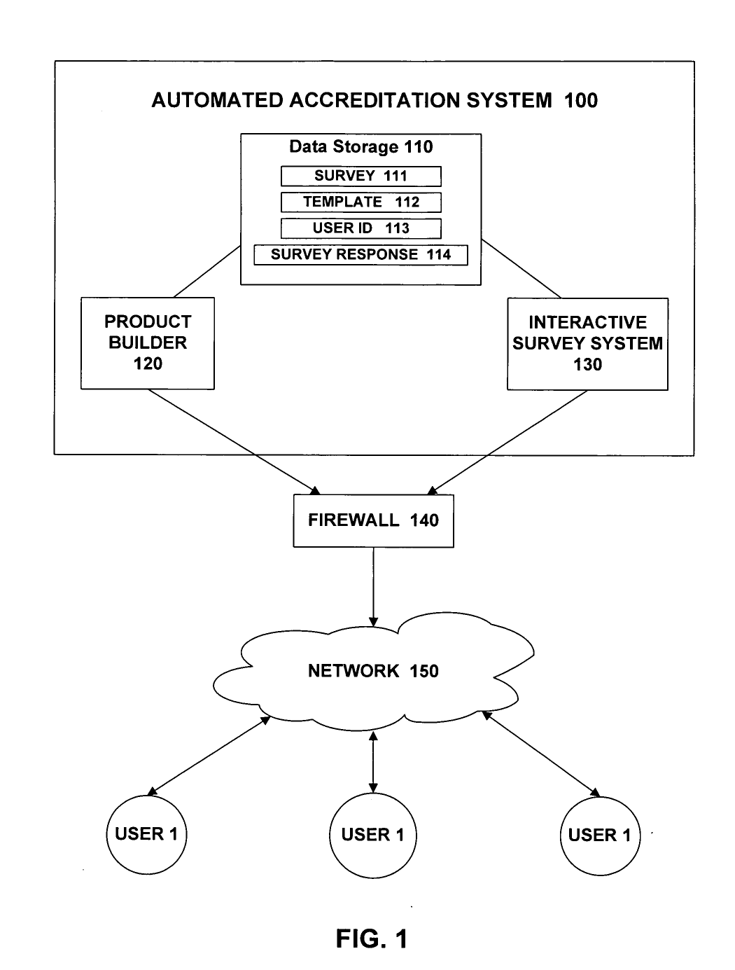

As depicted in FIG. 1, various embodiments of the present invention enable In response to these and other needs, the present invention provides a sophisticated online accreditation and certification platform that substantially streamlines the oversight process, reducing the duration of the on-site survey, eliminating paper and allowing for the efficient, electronic transfer of documents. In addition, the online process is interactive, allowing users to get up-front feedback on standards compliance and perform a self-assessment prior to their actual survey.

The present invention provides an automated accreditation tool (AAT) 100 for accreditation and certification programs. As described in greater detail below, the present invention represents a unique and novel online accreditation/certification platform, and also provides a significant step forward in online program documentation. Web-based assessment emphasizes the collection and exchange of information via the Internet, allowing for shorter, more efficient reviews. It also allows participating organizations to perform a complete self-assessment prior to their survey.

Referring now to FIG. 1, the AAT 100 generally comprises a Standards and Guideline (“SG”) definition tool 120 (also referred to as a Product Builder) that assists a user 1 in the creation and definition of an accreditation survey 111 that is stored in a data storage device 110. The AAT 100 further includes a Survey Tool (“ST”) 130 (also referred to as an Interactive Survey Tool) that accesses the data storage device 110 to acquire the survey 111. The ST 130 then presents the survey 111 to a user 1 and accepts responses and supporting data. User 1 generally connects to the ATT 100 through a network 150, such as an internet, extranet, or intranet operating according to TCP/IP protocol. The network 150 is separated from the AAT 100 by a firewall 140 that monitors and controls users access. In this way, the present invention provides an interactive, web-based platform that supports every aspect of Accreditation and certification.

The SG 120 may present all of the information from the traditional hard-copy publications—the standards, elements, scoring, explanations, examples, supplemental worksheets, policies and procedures, and appendices in a searchable, layered format. The SG 120 is imbedded in the ST 130 provides additional functionality to supports all aspects of the accreditation survey, including comments to support the assessment and send the data and documents via the web to an accrediting/certifying body as part of a survey.

The ST 130 reduces the paperwork and binder preparation previously associated with the survey process and allows users to prepare and submit accreditation materials electronically. Because much of the survey will be conducted off-site through use of the survey tool, any on-site portion of the survey process may be reduced in length and scope. As described below, the ST 130 further permits a user 1 to conduct an evaluation to help determine readiness for a review and identify areas of special concern.

In another embodiment of the present invention, the ST 130 may further include documentation regarding the Standards and Guidelines for Accreditation and Certification that detail the applicable standards for each Accreditation and Certification product. A user may access this data to obtain information on the accreditation standards and criteria.

The operation of the SG 120 and the ST 130 are described below in greater detail.

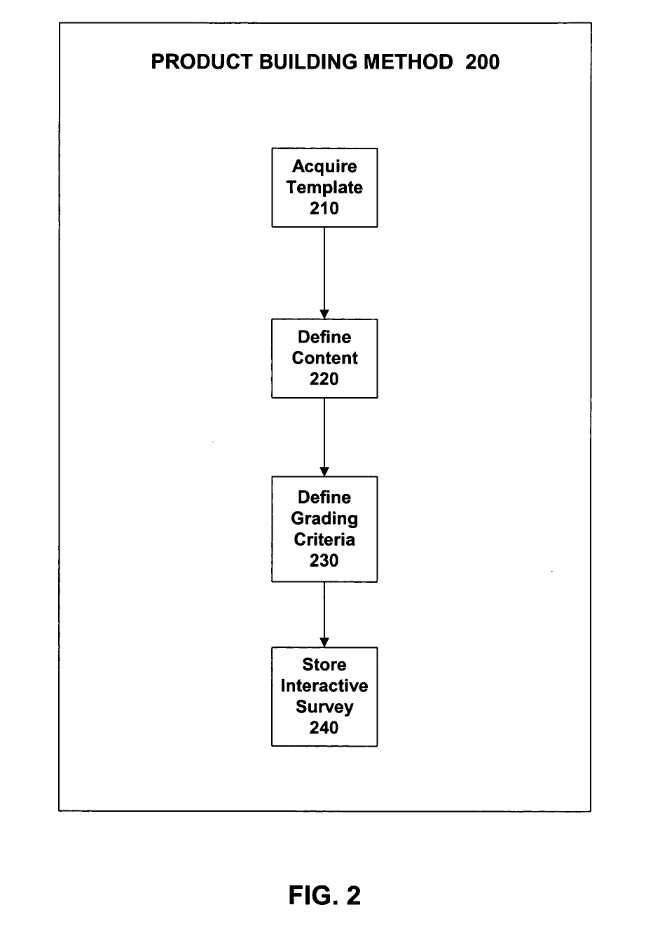

The operation of the SG 120 is generally described in a survey building method 200 depicted in FIG. 2. As described above, the SG 120 generally functions to automate the process of forming an accreditation survey 111. The survey building method 200 may begin with the selection of a question template 112 in step 210. The question template 112 may be stored in the data storage device 110 (or equivalent device or system). The template provides a general format for the question and for possible answers. For example, the template 112 may assist in the formation of a multiple-choice question by providing entry for the question block and of the each of the possible answers. User then provides content to fill out the template 112 in step 220. The data may be entered manually or automatically transferred from other data repositories. It should be appreciated that other types of question formats (e.g., true/false selection, selection of a numerical value from possible ranges, etc.), are generally known and may be employed.

Once the questions in the survey are created, the user may then define grading criteria for the survey questions in step 230. In this process, the user 1 provides data, such as a numerical scaling, as needed to quantify the accreditation standards. For example, accreditation typically entails achieving a minimum point total for demonstrating compliance with accreditation criteria. Continuing with step 230, the user 1 may further associate numerical values to each of the questions and possible answers defined in step 220.

Continuing with step 230, the user 1 provides data as needed to define standards for accreditation. For instance, the user defines an aggregate score or percentage (according to the scoring system associated with the questions and answers). Similarly, user 1 may specify that certain criteria must be satisfied as reflected by answers. In other words, the user 1 who creates the survey may specific that certain answers are required for certification, regardless of results from other questions. For example, a minimum staffing level may be required, and failing to meet this staffing level may not be overcome by additional training of existing staff or through additional machinery.

Once the questions are created in step 220 and the grading criteria are defined in step 230, the resulting accreditation survey 113 is stored in step 240. For example, the data provided in steps 220 and 230 may be stored in the storage device 110. The storage device 110 is generally a know technology for semi-permanent data storage. The storage device 110 may incorporate some type of known database management system (not illustrated) to ease the organization and access of the data.

It should be appreciated that multiple different accreditations may be implement using the AAT 100. Thus, several surveys 113 may be stored on the storage device 110, as needed.

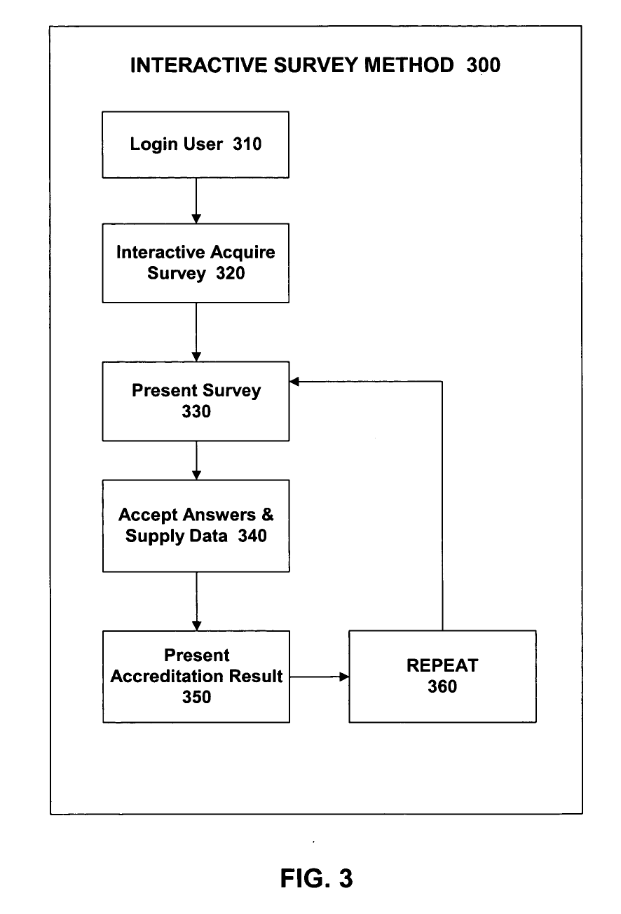

Turning now to FIG. 3, an interactive survey method 300 provides a method for allowing a user 1 (such as an accreditation official, a person from the organization being accredited, or a third party) to take the survey and automatically receive an accreditation adjudication. Since different types of user 1 may access the AAT 100 and since the AAT may store several the different accreditation surveys 113, the interactive survey method 300 may start with logging in the user in step 310. In step 310, the user provides some type of identifier that allows the user to bypass the firewall 140 and to access the stored data. Likewise, the user's identifier may enable the user 1 to access particular stored data or survey.

After logging in step 310, the ST 130 allows an organization to share information during the interactive survey process 300 within the organization by giving designated staff access to the ST 130. Typically, the organization creates and manages its own user identifiers and passwords, giving it control of access.

The present invention preferably includes various levels of access so that different persons in an organization can view data from any PC with Internet access. An optional feature may allow users to communicate with one another without concern that a surveyor will view these comments.

Once the user 1 has logged into the system, the user 1 can acquire the appropriate interactive survey in step 320. As described in greater detail below, the user can request the survey by way of a TCP/IP request embodied in an internet address.

The requested survey is then provided to the user in step 330. Typically, the ST 130 serves the survey to the user 1 using known techniques. The user 1 may then view the survey contents using known technology, such as web browser.

Embodiments of the present invention may employ an interactive accreditation survey that is implemented using a network comprising database sources of hypertext documents. The interactive survey system takes interactive surveys of users at client display stations for accessing and displaying, at a client display station, a hypertext document including a plurality of survey questions having user selectable answers, and means for triggering, by at least one of the user's answers, a hyperlink to a dynamically generated hypertext document including a different plurality of questions also having user selectable answers. The survey and, consequently, the hypertext documents may be readily available from Web or other network sources. This embodiment is preferably implemented through a Web browser at the client display station that includes both the means for accessing and displaying at a client display station a hypertext document including a plurality of survey questions having user selectable answers, as well as the means for triggering by at least one of said answers a hyperlink to a dynamically generated hypertext document. The documents or pages used in the surveys are preferably dynamically generated HTML documents, such as DHTML, that use scripting languages, such as Javasript, in the generation of HTML pages.

Before going further into the details of specific embodiments, it will be helpful to understand from a more general perspective the various elements and methods that may be related to the present invention. Since an aspect of the present invention is directed to Web documents, such as Web pages, transmitted over networks, an understanding of networks and their operating principles would be helpful. We will not go into great detail in describing the networks to which the present invention is applicable. The Internet or Web is a global network of a heterogeneous mix of computer technologies and operating systems. Objects are linked to other objects in the hierarchy through a variety of network server computers. These network servers are the key to network distribution, such as the distribution of Web pages and related documentation. In this connection, the term “documents” used to describe data transmitted over the Web or other networks and is intended to include Web pages with displayable text, graphics and other images.

Web documents are conventionally implemented in HTML language, as well known in the field of computer programming. In addition, aspects of this invention may involve Web browsers. The surveys of the present invention are implemented using the Java Programming system, which is an object oriented system utilizing the Java programming language. The Java system and language are extensively familiar to those skilled in the art. of object oriented programming. It should be understood by those skilled in the art that object oriented programming techniques involve the definition, creation, use and instruction of “objects”. These objects are software entities comprising data elements or attributes and methods that manipulate the data elements. The data and related methods are treated by the software as an entity and can be created, used and deleted as such. The data and functions enable objects to model their real world equivalent entity in terms of its attributes, which can be presented by the data elements, and its behavior, which can be represented by its methods.

The survey that is distributed or input to server is in the form of a Java program servelet written in the XML (Extensive Markup Language) language. These Java servelets are executable programs designed to be run on servers that are distributable over the Web.

With respect to the XML in which the survey is written, unlike HTML, its markup tags are not fixed or predefined sets; XML tags are extensible on a case-by-case basis. The protocols of XML are established and maintained by the W3C organization (World Wide Web Consortium-Web site: www.w3.org). In general, XML has a hierarchical data format whereby data elements may be nested within other data elements and have their associated attributes. Thus, the present XML survey file contains an extensive set of questions and their potential answers as strings of text surrounded by text markups, including tags that define the data elements and attributes that define associations, question answers and/or sets of answers may be used to trigger the dynamic forming of new subsets of questions in dynamically HTML generated pages to be presented to client users, as will be subsequently described.

These dynamically generated pages are formed through DHTML functions performed by the Java servelets through the selective parsing of the received XML survey files into JavaScript language files that are then selectively added to the HTML that will provide the displayed dynamically generated survey screen presented to the user taking the survey. Dynamic HTML allows the addition of command files or scripts through which HTML supporting the individual display screens may be augmented with embedded objects. This may be done in response to triggering events.

Returning now to FIG. 3, in step 340, user 1 provides data in response to the survey. Typically, a browser may accept the users' input in response to the displayed survey, and the user's inputs may be forwarded the ST 130 via known technology. The user's input may include answers to the survey questions. The user's input may further include support documentation, as needed to support the provided answers. For example, the user may be asked to provide documentary evidence of facility maintenance or employee training. In this way, the present invention's provides an interactive, online Web-based tool that allows organizations to transfer supporting information and documentation, reducing the amount of time on site. The result is surveying lower costs and expedited turnaround time for results. During the review, the accrediting/surveying authority and participating organizations exchange documents over the Web via secure, encrypted transfers. Documents used to demonstrate compliance with the standards may be attached in electronic format to the ST 130 and submitted with the data, using a document library in the data storage device 110 that permits the documents to be referenced to the standards and elements. A document library in the storage device 110 may used to track those documents identified by the organization as demonstrating compliance for standards. The document library often categorizes documents alphabetically and by standard and references the particular element(s) that applies to each document. Organizations may then use this library to keep all their documents updated and organized for future use.

While the user's inputs may be stored in the above-described data storage device 110 as user inputs 114, as described above, the data or documents may remain also on the user's 1 computers or servers until submission, so a reviewing authority has no means to access them. Preferably, any data entered is stored on the ST 130 and the data storage 110 after submission. However, prior to submission, the data is stored in a secured area that is partitioned from the data for organizations under review. In this way, the present invention allows organizations to perform, at its own pace, a confidential self-assessment before submitting data to an accrediting/certifying authority.

Thus, the present invention, not only shorten the duration of future on-site surveys, but also allow entities undergoing surveys to archive, modify and transfer documents and information electronically, eliminating paper and binders; provide multiple staff with access to survey-related documentation and allow updates to various sections of the survey materials at the same time; perform a self-assessment to gauge readiness for a survey; and view scores on individual elements or summary scores on various standards or sections of standards.

In a preferred embodiment, the present invention may further include an automated Completeness Check in data collection in step 340 that automatically scans submission and flags any elements with no data.

Continuing with FIG. 3, the data provided by the user is then used to prepare an accreditation result in step 350. Usually, the user's inputs are scored according the criteria defined in the survey building method 200 described above. Alternatively, the user's responses and supporting data may be forwarded to a scoring official who analyzes the response for scoring purposes. Even where the user's responses need to be manually scored or if the supporting documentation must be verified in order to allow accreditation, an estimated score may be produced in step 350 for the purpose of guiding the user.

In addition, the embodiments of the present invention may allow each organization to receive a detailed performance report with accreditation or certification decisions in step 350. These reports may help organizations identify areas where improvement is needed, allowing them to develop enhanced, more effective quality improvement initiatives, and to prepare more effectively for subsequent reviews.

If an accrediting/certifying authority carries out survey, the accrediting/certifying authority may use the ST 130 to conduct the accreditation survey. During the accreditation process, as the ST 130 progresses through the stages of the survey, a phase of comments by the organization on preliminary results, and final decision-making, the organization may have access to specific data at stages specified in the operational processes. In general, these stages are the initial submission, the period where the organization reviews and provides comments on preliminary results and the final results. The organization usually has the ability to read any completed stages to which it had access rights.

In step 350, an organization's final results may be presented electronically. Instead of receiving a paper report, the organization may be notified that final results are available after the committee decision review and logs into a web-based ST 130 access their summary results, detailed results and score sheet. The organization may then print a copy of the final results.

Given the accreditation results in steps 350, the user may then repeat the survey as needed, step 360. For example, the user may implement changes and then change survey answers to reflect these changes. Thus, a user receives guidance as to steps necessary to achieve accreditation. In this way, the present invention is structured so that organizations will be able to prepare themselves for a review more quickly and effectively-information is requested in a logical, layered manner, allowing for a quick, orderly transition of information from company databases to the accrediting/surveying authority.

Embodiments of the present invention may also include a version control that allows an organization to have several different versions of survey response data 114. In order to ensure data integrity, the AAT 100 generally may not allow two users on the same data entry page at a time.

At any point in the interactive survey process 300, the user 1 may use the ST 130 print a copy of certain content present in the final stages to which it has access rights (i.e., initial submissions, preliminary results, final results). Similarly, surveyors and staff of accrediting/certifying authority may be given access to designated areas of the AAT 100 to review an organization's data and documents. At the appropriate point in the process, the decision-making committee reviews the data and documents by accessing the ST, and enters its decisions in a secure area specifically designed to support that function.

In other embodiments, the present invention also provides tools organizations can use to assess their readiness using the interactive survey method 300. For example, at the start of the accreditation survey, the ST 130 may permit an organization to complete a pre-survey assessment by answering questions presented by the ST 130 the interactive survey 113. The organization then uses the ST 130 submit the survey answers electronically to the accrediting/certifying authority. Based on this pre-survey assessment, the organization can see numerical score from step 350, which can help focus the survey preparation.

Thus, during the process 300, a user 1 is given an opportunity to review preliminary results of the survey in step 350 by accessing the web-based survey tool. In this way, the ST 130 then provides organizations with a process to present their comments on the preliminary results to accrediting/certifying authority electronically.

The self-assessment feature of the present invention allows an organization to answer the same questions for each element that surveyors complete while conducting a survey. Based on the data entered for the element, an organization can view its score on that element. In addition, once all the element data is complete, an organization may view aggregate scores at the standard, category and total Accreditation or Certification product level. In addition, if the score is below a specific threshold, the present invention may provide a recommendation on steps for improvement.

Thus, it can be seen that the current invention efficiently evaluates a variety of organizations and makes maximum use of electronic information. The system and method of the present invention improve the accreditation process by focusing on the policy (how to present the standards and the development process), process (how the surveys are conducted), and the systems to support both. This includes migrating the products to web-based tools to deliver the standards and collect data. Furthermore, the present invention improves an organization's experience with an accrediting/certifying organization, enhances product development, improves information architecture and increases operational efficiency.

Other aspects of the present invention are depicted in Table 1:

TABLE 1
Other Features

The ability to collect data and calculate a percent
score for a scoring element;
The ability to link documents to elements to support
scoring
The ability to set review parameters, such as which
evaluation option (subset of standards) and which
diseases to be evaluated on
A search function
An electronic glossary
Various print features, including printer-friendly
version with completed data
The ability to calculate and view numeric results
The ability to develop products that allow for results
aggregated or disaggretaed at sub-units with a client
organization (generically “units of assessment”, more
commonly product/product lines, disease programs,
business units, etc)
The ability to submit data and documents for a survey
via the Web
The ability to receive and upload documents transmitted
via CD
The physical separation of a customers confidential pre-
survey data from data submitted for survey data and
documents for customer privacy reassurance
The ability to move the data through “versions” or
“stages” that constitute the review process
The calculation of “Must Pass” scoring (elements that
require a minimum score or the accreditation status is
capped)
The ability to load system on laptop and mini-LAN to
take to onsite review
The ability to re-synchronize data from an onsite survey
A Product Builder that allows the creation and
modification of an online survey as needed for the
certification/accreditation of all kinds of
organizations, including health care organizations.
Specifically, this tool allows a user to specify the
text of the survey and to scoring system used to
evaluate the inputs provided by an organization
undergoing an accreditation or certification survey
The ability to maintain and present more than one survey
as needed for types of health care plans and services on
the platform
An document library features to allow more functionality
(add, delete, edit) from central library as well as
different sort features
Modified user login and time out settings to allow users
to reset sessions
Evaluation text/comments screens that allow different
types of comments at different stages
The ability to provide recommendations automatically for
any element scoring below a threshold
The ability for private notes for internal and external
users
Expanded users rights/roles customization by different
features and by department in the system that allow
different access and editing rights for different
users/reviewers
A module in Product Builder for business users to
construct and customize this role-based access for each
product
The ability for customers to self-administer access to
the tool, and to control access by category
An administrative module that logs a history of who made
the last edit or addition to data for tracking purposes
The ability to view data in a reviewer friendly manner
(e.g. linear scroll vs. page flip)
A secure comment area to enter decision information
A “What's New” notice feature
A completeness check to missing data
The ability to use the online survey results to
encourage quality improvement in health care by
recognizing and rewarding health care providers who
demonstrate that they deliver effective, efficient and
patient-centered care. Physicians who demonstrate high
levels of performance may be eligible for incentive
bonuses.
The ability for communication with internal enterprise
information system, including information on projects
and applications
The ability to integrate HEDIS ® data into the evaluation
process, including calculation of Health Plan Report
Card ® “Stars”
The ability to accommodate “not applicable” responses
via a process that proportionally reallocates points
within a category or across multiple standards
The ability to designate the delegation oversight
standard and allowing points to be reallocated among
standards in a category
Improved instructions
The ability to activate a Lookback Period
The ability to allow users to assign different levels of
rights and access to users of their SG/STs.
The ability to allow staff to proof scoring programming
at the element level
The ability to modify the way Product Builder and Survey
Tool collect data to allow for more flexibility in the
types of questions we can use and the detailed level of
data collection
The ability to link Survey Tools allowing one ST to
provide the data/answers to other explicitly linked STs
The ability to generate a new license for “re-review” of
selected elements, and present only required elements to
customers for re-entry, without requiring an additional
e-commerce transaction
The process of allowing single elements to be combined
in a variety of way to present a “focused evaluation of
related subsets” by various “Evaluation Options” within
a single “Product Suite”
The auto-creation of final approval with seals based on
a certain stage in the process being reached within a
range of acceptable auto-computed point scores
Auto creation of RDS user id and licenses via purchases
in the eCommerce system that allows immediate access to
the tool upon purchase.

One skilled in the art should appreciate that the processes controlling the present invention are capable of being distributed in the form of computer readable media of a variety of forms.

### EXAMPLE

When selecting health care plans or health care services, individuals and businesses are faced with a myriad of potential choices. Selecting health care plans or services is a complex decision because of different mixes of services and costs offered by the plans and services. Health care plans and services may be evaluated using various performance measures in such key areas as member satisfaction, quality of care, access, and service. To assist in these decisions, health care plans or services may be grouped together into classes offering particular features, thereby allowing providing information on their relative quality and value. For instance, plans or services may be “accredited” certified if they are reviewed and certified by the National Committee for Quality Assurance (NCQA) and meet certain standards. See www.NCQA.org for more information on accreditation and certification of health care plans or services.

Accreditation is designed to help employers and consumers distinguish between health plans based on quality. Accreditation evaluates not only the core systems and process that make up a health plan, but the results that plan actually achieves on key dimensions of care and service. The review process is rigorous, generally consisting of evaluations conducted by teams of physicians and managed care experts. A national oversight committee of physicians further analyzes the team's findings and assigns an accreditation level based on the plan's compliance with standards and the health care organization's performance relative to other plans on selected performance measures. The requirements for certification and accreditation, developed with the input and support of employers, unions, health plans and consumers, are generally demanding to encourage health plans to continuously enhance their quality.

A variety of organizations from Health Maintenance Organizations (HMOs) to Participating Physicians Organizations (PPOS) to Managed Behavioral Healthcare Organizations (MBHOs) may be accredited, and each accreditation program is distinct. In the same way, various chronic disease management (DM) programs may be accredited and certified. In each case, the plans or services are objectively reviewed against a set of standards. For instance, HMO plans undergoing accreditation are reviewed against more than 60 different standards designed to evaluate the health plan's clinical and administrative systems related to such issues as consumer protection, confidentiality, and customer service. These plans also report on their clinical performance, using a measurement tool known as Health Plan Employer Data and Information Set (HEDIS®) performance measures such as immunization rates, mammography rates, and member satisfaction. For more information on HEDIS, see http://www.ncqa.org/Programs/HEDIS/, the contents of which are incorporated by reference. These standards and performance measures of HMOs fall into five broad categories:
Access and Service—Do health plan members have access to the care and service they need? For example: Do patients report problems getting needed care? How well does the health plan follow up on grievances?
Qualified Providers—Does the health plan assess each doctor's qualifications and what health plan members say about their providers? For example: does the health plan regularly check the licenses and training of physicians?
Staying Healthy—Does the health plan help people maintain good health and avoid illness? children receive all appropriate immunizations? Do women receive mammograms as recommended?
Getting Better—How well does the health plan care for people when they become sick? How does the health plan evaluate new medical procedures, drugs and devices to ensure that patients have access to safe and effective care?
Living with Illness—How well does the health plan care for people with chronic conditions? Do diabetics, who are at risk for blindness, receive eye exams as needed?

In contrast, other health care plans, such as PPOs, do not generally manage health care the same way HMOs do, so these health plans are not evaluated in view of the Staying Healthy, Getting Better and Living with Illness categories. It should be appreciated that the other factors and various combinations of factors may be used to evaluate various health care plans and services.

Based on that review, information on the quality and value of the plans or services are developed and made publicly available to inform consumers' and employers' enrollment or contracting decisions. For instance, various possible accreditation levels may be assigned to a health plan based on the plan's performance. In this way, accreditation and certification allows individuals and businesses to make more informed health care purchasing decisions. Furthermore, the informed purchasing decisions encourage improvements in health care quality and value.

Conclusion

The foregoing description of the preferred embodiments of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. Many embodiments of the invention can be made without departing from the spirit and scope of the invention.

1. An automated accreditation system comprising:
a questionnaire creation tool, said survey creation system receiving questionnaire data and using the questionnaire data to define a questionnaire and scoring criteria for assessing accreditation;
a storage device connected to said questionnaire creation tool to store said questionnaire and said scoring criteria; and
a survey tool connected to said storage device, said survey tool administering said questionnaire to a user, accepting a first response from said user, and evaluating said response in view of said criteria.

2. The automated accreditation system of claim 1 further comprising:
a network that connects said user to said survey tool; and
a firewall that receives identifying information from said user and uses said identifying information to control said user's access to said survey tool.

3. The automated accreditation system of claim 2, wherein:
said questionnaire creation tool defines a plurality of questionnaires and a plurality of scoring criteria, each of said questionnaires being associated with one of said scoring criteria,
said storage device stores said plurality of questionnaires and said plurality of scoring criteria, and
the survey tool administers one of said questionnaire selected according to said identifying information, said survey tool evaluating said first response in view of said associated scoring criteria.

4. The automated accreditation system of claim 1, wherein the survey tool presents a result of said evaluation to said user.

5. The automated accreditation system of claim 4, wherein the survey tool:
re-administers said questionnaire to said user,
accepts a second response from said user,
evaluates said second response in view of said criteria, and
compares said result from evaluation of said first response and a result from evaluation of said second response.

6. The automated accreditation system of claim 1, wherein the survey tool requests, accepts and stores supporting data from said user as needed for accreditation as specified by said scoring criteria.

7. The automated accreditation system of claim 1 wherein said questionnaire comprises a first question and second question, and wherein said second question is dynamically formed in response to a reply to the first question.

8. An automated accreditation method for implementation on a computer, the method comprising the steps of:
A user interfacing with a survey creation system on a computer;
the user forwarding questionnaire data to said survey creation system, said questionnaire data defining a questionnaire scoring criteria for assessing accreditation, and wherein said survey creation system on the computer automatically creates and stores a questionnaire;
the computer administering said questionnaire to a user
the computer accepting a first response from said user, and
the computer forwarding said first response to a survey tool, wherein the survey tool evaluates said response in view of said criteria.

9. The automated accreditation method of claim 8 wherein a network connects said user to said survey tool; and wherein a firewall receives identifying information from said user and uses said identifying information to control said user's access to said survey tool.

10. The automated accreditation method of claim 9, wherein said questionnaire creation tool defines a plurality of questionnaires and a plurality of scoring criteria, wherein each of said questionnaires being associated with one of said scoring criteria, and the questionnaire administered to said user is selected according to said identifying information, said survey tool evaluating said first response in view of said associated scoring criteria.

11. The automated accreditation method of claim 8 further comprising the step of said survey tool presenting a result of said evaluation to said user.

12. The automated accreditation method of claim 11 further comprising the steps of:
the computer re-administering said questionnaire to said user,
the computer accepting a second response from said user,
the computer forwarding said second response to said survey tool that evaluates said second response in view of said criteria, and
the computer compares said result from evaluation of said first response and a result from evaluation of said second response.

13. The automated accreditation method of claim 8, further comprising the step of the survey tool accepting and storing supporting data from said user as needed for accreditation as specified by said scoring criteria.

14. The automated accreditation method of claim 8 wherein said questionnaire comprises a first question and second question, and wherein the step of administering said questionnaire to the user comprises dynamically forming said second question in response to a reply to the first question.

15. A computer program embodied on a computer readable medium for performing an automated accreditation:
a code segment for interfacing with a survey storage system containing a questionnaire and scoring criteria for assessing accreditation;
a code segment for administering said questionnaire to a user;
a code segment for accepting a first response from said user;
a code segment for accepting said first response; and
a code segment for automatically evaluating said response in view of said criteria.

16. The computer program of claim 15 further comprising a code segment for receiving identifying information from said user and for using said identifying information to control said user's access to said questionnaire.

17. The computer program of claim 16,
wherein said survey storage system contains a plurality of questionnaires and a plurality of scoring criteria, each of said questionnaires being associated with one of said scoring criteria,
wherein the questionnaire administering code segment selects a questionnaire according to said user identifying information, and
wherein said response evaluating code segment evaluates said first response in view of said associated scoring criteria.

18. The computer program of claim 15 further comprising a code segment for presenting a result of said evaluation to said user.

19. The computer program of claim 18, wherein
said question administering code segment re-administers said questionnaire to said user,
said acceptance code segment accepts a second response from said user,
said response evaluating code segment evaluates said second response in view of said criteria, and
further comprising a code segment for comparing said result from evaluation of said first response and a result from evaluation of said second response.

20. The computer program of claim 15, further comprising a code segment for accepting and storing supporting data from said user as needed for accreditation as specified by said scoring criteria.

21. The computer program of claim 15 further comprising a code segment for dynamically forming said questionnaire, wherein said questionnaire comprises a first question and a second question, and wherein said dynamic questionnaire forming code segment forms said second question in response to a reply to the first question.
